(19) United States
(12) Patent Application Publication
(10) Pub. No.: US 2019/0258496 A1
(43) Pub. Date: Aug. 22, 2019

(54) A MULTIMEDIA SYSTEM AND A METHOD FOR REMOTE ADMINISTRATION AND MANAGEMENT OF A TERMINAL IN THE SYSTEM

(71) Applicants: Roger Alan VINTON, Dartford (GB); Roger Nicholas MCARDELL, Dartford (GB)

(72) Inventors: Roger Alan VINTON, Dartford (GB); Roger Nicholas MCARDELL, Dartford (GB)

(21) Appl. No.: 16/318,713

(22) PCT Filed: Jul. 18, 2017
(86) PCT No.: PCT/EP2017/068096

§ 371 Date: Jan. 18, 2019

(30) Foreign Application Priority Data
Jul. 22, 2016 (GB) 1612732.6

(51) Int. Cl. G06F 9/451; H04L 12/26; H04L 29/06; H04L 12/18

(52) U.S. Cl. CPC G06F 9/452; H04L 43/0817; H04L 12/1813; H04L 63/083; H04L 63/0876; H04L 43/065

(57) ABSTRACT

A method for remote administration and management of a terminal in a multimedia system, the method comprising receiving, at a remote management apparatus, a unique identification from the terminal, selecting, at the remote apparatus, a terminal operation parameter relating to the unique identification, using the terminal operation parameter, generating a profile for the terminal configured to enable or disable one or more terminal applications and/or functions and transmitting the generated profile to the terminal.

### TECHNICAL FIELD

Aspects relate, in general, to a multimedia system and a method for remote administration and management of a terminal in the system.

### BACKGROUND

Collaboration systems typically comprise a number of end-points communicating real-time video, audio and/or data streams over and between various networks such as a Wide Area Network (WAN), Local Area Network (LAN), and circuit switched networks.

A management tool is typically deployed on bespoke equipment which can be used to control the specific apparatus at the end-points. For example, a pair of terminals providing audio-visual and data communication functionality will use a management tool that enables the terminals to communicate with one another and encode/decode data. The management tool will also enable event scheduling, execution and termination as desired, and once a user has accessed the end-point, they will typically have unlimited access to and control of all of the functionality of the end-point terminal and control.

In, for example, a corporate environment, it can be desirable to remove the ability for a user to be able to individually control terminals.

### SUMMARY

According to an example, there is provided method for remote administration and management of a terminal in a multimedia system, the method comprising receiving, at a remote management apparatus, a unique identification from the terminal, selecting, at the remote apparatus, a terminal operation parameter relating to the unique identification, using the terminal operation parameter, generating a profile for the terminal configured to enable or disable one or more terminal applications and/or functions and transmitting the generated profile to the terminal. The unique identification can relate or correspond to a terminal login configured to govern the functionality of the terminal. The terminal login can map to or otherwise be associated with a terminal operational parameter configured to reduce, limit, maintain or otherwise enhance the terminal functionality. The method can further comprise transmitting data for broadcast at the terminal at a predetermined time, storing the data at the terminal until the predetermined time and executing a broadcast at the terminal using the stored data at the predetermined time or in response to a trigger signal received at the terminal from the remote management apparatus, wherein the broadcast is configured for execution irrespective of a current profile for the terminal. The method can further comprise transmitting metric data from the terminal to the remote management apparatus, the metric data representing one or more usage parameters of the terminal and/or a terminal application. The remote management apparatus can be a virtual machine instantiated over physical hardware, the method further comprising executing horizontal and/or vertical scaling of the remote management apparatus in response to a load variation as a result of a change to the number of active terminals of the videoconferencing system. Generating the profile can include populating the profile with user password information. The remote management apparatus can be used to override functions and/or applications executing on the terminal. The terminal can be disabled in response to a predefined command or instruction transmitted by the remote management apparatus. The terminal can be disabled at a predetermined time.

According to an example, there is provided a multimedia system, comprising a remote management apparatus and a terminal, the remote management apparatus operable to receive a unique identification from the terminal, select a terminal operation parameter relating to the unique identification, use the terminal operation parameter to generate a profile for the terminal, the profile being configured to enable or disable one or more terminal applications and/or functions and transmit the generated profile to the terminal. The remote management apparatus can map or logically associate the unique identification to a terminal operational parameter that is provided or configured to reduce, limit, maintain or otherwise enhance the terminal functionality. The remote management apparatus can transmit data for broadcast to the terminal at a predetermined time, the terminal operable to store the data until the predetermined time and execute a broadcast using the stored data at the predetermined time or in response to a trigger signal received at the terminal from the remote management apparatus, wherein the broadcast is configured for execution irrespective of a current profile for the terminal. The remote management apparatus can receive metric data from the terminal representing one or more usage parameters of the terminal and/or a terminal application. The remote management apparatus can be a virtual machine instantiated over physical hardware. The system can execute horizontal and/or vertical scaling of the remote management apparatus in response to a load variation as a result of a change to the number of active terminals of the videoconferencing system.

### BRIEF DESCRIPTION OF THE DRAWINGS

Embodiments will now be described, by way of example only, with reference to the accompanying drawings, in which:

FIG. 1 is a schematic representation of a system according to an example;

FIG. 2 is a schematic representation of a message flow between a terminal and a remote management apparatus according to an example; and

FIG. 3 is a schematic representation of a multimedia system according to an example.

### DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

With off the shelf, inexpensive televisions now supporting high resolution computer connections, many companies simply buy a cheap television, mount it on the wall in a room and run a cable to a table in the room in order to enable the television to act as a display which can be connected to a laptop for example and used for collaborative purposes. This is typically fine for smaller companies, but for larger companies there are challenges around supporting individual, multiple, and usually different, TVs in different locations. Standard “smart” TV's offer no remote management capability and allow unrestricted connectivity to the internet which is both risky and bandwidth hungry.

“Smart” features using dedicated applications included on TV's have become standard on almost all televisions and there are many standalone Internet TV boxes such as Apple TV, Roku, Google Chromecast and NowTV to name just a few. However, no dedicated corporate version is available.

According to an example, a system and method as described herein can provide conference room presentation connectivity features as well as smart application functionality coupled with the ability to enable control and management of the functions and applications of a device or terminal serving as an end-point in a collaborative environment or multimedia system. As used herein, a terminal can include a television or display which may include processing and connectivity functionality, such as the ability to connect to the internet or other network using a wired or wireless protocol and the ability to execute applications such as streaming, videoconference and collaborative applications.

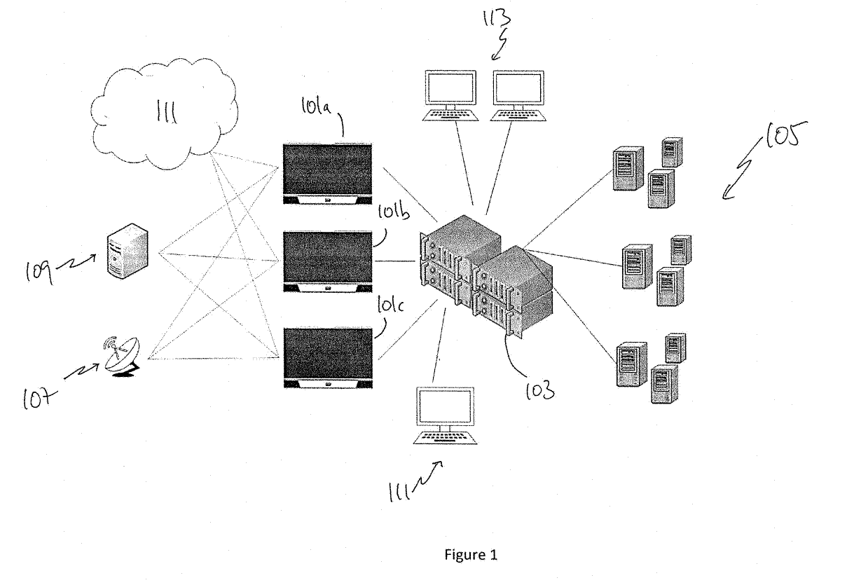

FIG. 1 is a schematic representation of a multimedia system according to an example. A terminal 101a is remotely administered and managed using remote management apparatus 103. The apparatus 103 can be geographically remote from the terminal 101a such as in a different room of a building, a different building, city or country for example. The remote management apparatus 103 can be communicatively coupled or linked with the terminal 101a using a network (not shown) such as the internet for example, which may include wired and/or wireless components. The remote management apparatus 103 can remotely administer and manage multiple terminals. For the sake of clarity, only three such terminals 101a-c are depicted in FIG. 1.

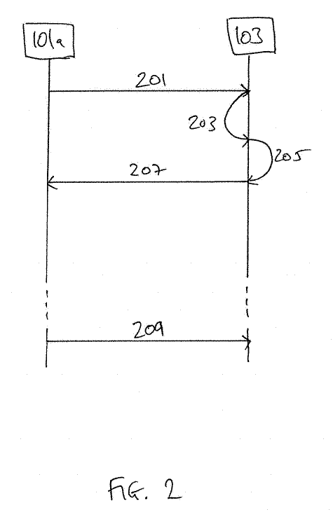

With reference to FIG. 2, which is a schematic representation of a messaging process for a multimedia system according to an example, the remote management apparatus 103 is configured to receive a unique identification 201 from the terminal 101a. The identification can be in the form a login or other identifier, which may be provided for the user to enable them to operate the terminal. For example, a user who wishes to use terminal 101a may be provided with credentials or a login username and password to enable the user to access the terminal 101a, as is typical. In an example, the identification provided by a user wishing to operate terminal 101a may be a biometric identifier such as a fingerprint or facial identifier. For example, facial recognition, which may be coupled to a stored image of a user, such as an image which includes multiple image layers visible in different regions of the spectrum for example, e.g. a visible light portion and an infra-red portion, may be used to authenticate a user, whereby to verify that the user has the required credentials to use the terminal.

Accordingly, a user who has a predefined identifier that can be used to operate the terminal can activate the terminal 101a. In this connection, it will be appreciated that one or more of multiple input methods may be used by a user. For example, a keyboard may be provided to enable a user to input text for a username and/or password. Other typical examples can include the use of a camera to image the user such as the face of the user, a fingerprint scanner, a near-field communication device coupled or otherwise provided on the terminal to enable the user to authenticate themselves using, for example, a smart phone which includes a unique identifier for the user, an audio device such as a microphone to receive spoken word to enable spoken user input (e.g. in lieu of a keyboard) and/or voice recognition and so on.

The unique identifier, which is used to authenticate or otherwise validate that a user is permitted to use the terminal 101a, is transmitted by the terminal 101a (e.g. over a network such as the internet for example, in encrypted form) to the remote management apparatus 103.

At the remote management apparatus 103 a terminal operation parameter 203 relating to the unique identification is selected. That is, upon receipt of the unique identifier, the remote management apparatus 103 selects a terminal operation parameter 203 based on the unique identifier. For example, consider two groups of potential users of terminal 100a. Each user in respective ones of the groups may be provided with login details to access terminal 100a with the login details for users of one group being different to the login details for users of the other group. The scope of use of terminal 100a may therefore be different for each group of users, with one group able to access a subset of the features of the terminal 100a compared with the other group who may be able to access all features of the terminal 100a for example. A feature can include an application and/or hardware functionality of the device, such as network connection, videoconferencing and sound/video recording or playback functionality.

The remote management apparatus 103 is therefore preconfigured with information that maps respective ones of a set of unique identifiers 201 with one or more corresponding operational parameters 203 for a terminal. For a given identifier, there may be multiple operation parameters. For example, an operation parameter may be selected on the basis of not only the identity of a user attempting access to a terminal, but also taking into account various other parameters as well, such as, for example, the location of the terminal at the point access is requested, the load on the system which may include the determined bandwidth available for the terminal and so on. Accordingly, one user may experience different functionality from a terminal compared to another user and in fact one user may experience different functionality themselves from a terminal depending on other factors such as location (e.g. some functionality may be unavailable in one location for a user compared to another location). In the event that a unique identification has no corresponding operational parameter, a default parameter may be selected which enables access to the device but in a limited form or no access at all. For example, in the former case, a network connection may be disabled and access to a limited, or functionally reduced set of applications can be provided.

In order to provide varying functionality for a terminal, the remote management apparatus 103 can use the terminal operation parameter 203 to generate a profile 205 for the terminal 101 a which can be used to enable or disable one or more terminal applications and/or functions. Data 207 representing the profile 205 can be transmitted to the terminal 101a from the remote management apparatus 103.

In an example, a profile 205 can be in the form of mark-up to provide a set of instructions for a terminal 101a specifying the applications and/or functionality that should be provided. For example, a terminal may include a streaming application capable if streaming video over the internet (either live or recorded). One user may be permitted to use this application, and a profile can therefore be generated for the terminal, on the basis of the user's unique identification mapping to an operational parameter for the terminal, that enables the application for the user for the duration of their session (e.g. for the length of time they are logged into the terminal) or for a predetermined period of time that may be set according to the selected operational parameter and therefore provided as part of the profile.

Alternatively, for example, the same user may access the terminal from a different location in which use of the streaming application is not permitted or licensed. An operational parameter is therefore selected taking into account the terminal location, and the generated profile specifies that the application is disabled for the user (again either for the session duration or a predetermined period of time).

In an example, a profile for a terminal can be generated with reference to set of capabilities of the terminal. For example, the remote device 103 may include storage comprising a database with records relating the terminals 101a-c. For each terminal, a record can provide data representing the applications and functionality available to or on the terminal, such as installed or executable applications and functionality provided by hardware of the terminal for example. In an alternative or in addition, a terminal record can be stored on a remote storage device or server (not shown) that is accessible to the remote device 103, such as a cloud based storage utility for example. Accordingly, the remote device has at its disposal a listing, for each terminal, that enables it to determine what may be included in a profile for the terminal. That is, it can determine, from the set of all available applications and functions of the terminal as listed in a record for that terminal, which applications/functions to enable/disable on the basis of the operational parameter it derives from the unique identification. In some cases, all applications/functions will be enabled, and in other cases a subset may be enabled (or conversely, a corresponding subset may be disabled—e.g. if three applications [a,b,c] are available [a,b] may be positively enabled, or equivalently, [c] may be disabled with it being implicit that other available applications [a,b] are enabled.) A record for a terminal may be updated by an administrator. Alternatively, or in addition, a terminal may be able to transmit data to remote device 103 indicating a change in the applications/functions of the terminal to enable the record to be updated. For example, an administrator such as a local administrator or an authorised user may be able to modify the applications/functions of a terminal, which modifications can be notified to the remote device to update a record for the terminal.

Part of the profile 205 may include data relating to user password information. That is, for example, a profile may include password information for a set of applications that are to be enabled for the user on a terminal, whereby to enable those applications to be automatically executed by auto-populating or automatically providing the required passwords for the user. The profile may be encrypted before transmission from the remote management apparatus 103 to the terminal 101a. In this connection any number of known encryption/decryption techniques may be employed for this purpose at the apparatus 103 and terminal 101a.

In an example, encrypted password data for a user (that is, relating to a unique identification) can be stored on the remote device 103 or elsewhere (accessible to the remote device) and can be logically linked to a unique identifier. Upon receipt of a unique identifier, the remote device can access the corresponding passwords, either in encrypted form or unencrypted if a key is provided by a user or administrator for example or as part of the unique identifier, and the passwords needed to enable access to applications/functions can be provided to the terminal as part of the profile or as a separate encrypted file, which may be transmitted to the terminal separately from the profile. The profile can include a script or instructions to enable the terminal to apply passwords to enable the corresponding applications/functions.

A subset of password information may be selected by the remote device 103 depending on the operational parameter and hence the generated profile. For example, some application may be disabled, and so passwords for those applications need not be selected or provided as part of the profile.

In an example, data for broadcast at the terminal 10 la may be transmitted from the remote management apparatus 103 at a predetermined time. The data may be stored in a memory of the terminal (not shown) until the predetermined time, at which point the terminal can execute a broadcast using the stored data. Alternatively, a trigger signal received at the terminal (transmitted from the remote management apparatus for example) may be used to trigger the broadcast.

The terminal can be configured to transmit metric data 209 to the remote management apparatus 103 representing one or more usage parameters of the terminal and/or a terminal application. For example, metric data can comprise usage data including when the terminal is used, and how, i.e. which applications are being used, or which types of devices may be connected to a terminal. For example, a terminal may be in the form of a smart display, that is, a display which includes some processing and connectivity functionality, and a laptop computer may be connected to the terminal to enable it to be used as a primary or secondary display device for the laptop.

Metric data can include data relating to the number of people present in a room in which the terminal is located. For example, a camera can be provided at a terminal and face recognition technology can be used to count how many people are in the room at any given time.

According to an example, a terminal can use standard off the shelf applications but control their deployment and use as well as monitoring their operation. Bespoke applications can also be provided. Primarily, a management platform that allows a remote administrator 111 to fully control a terminal by way of a remote management apparatus is provided. This can include:
Application Management

The ability to remotely load, update and delete applications. A management tool can provide a snapshot of each application showing what version of each application is loaded onto each terminal. An administrator can schedule updates to applications, upload it to a new system or delete if not required.
Application Functionality

Some applications can have variable functionality. The administrator will need to be able to decide what terminals have what functionality and also what each user can see and use.
User Management

It is unlikely that all users in an organisation will be allowed to use all applications. Users can log into the system and be shown only the applications applicable to them. A series of different PIN numbers could be used to give this functionality as opposed to typical username/password combinations for user or groups of users. Alternatively, Near Field Communications (NFC) or smartphone generated barcodes can be used to automate the login process.
Content Push

For staff announcements and other important messages, a content push mechanism can be provided. This may be a live, multi-cast stream over a network or pre-recorded content that is pre-stored and then shown at a set time for example. Push messages can be launched and controlled at the remote management apparatus by, for example, an administrator.
Time Functions and Scheduling

The function of a terminal at certain times of day can be controlled. For example, this could be a simple turn-off at a preset time or it could be an instruction to override current functions and play a certain video for example. When combined with user management functions it could be that the system is disabled from say 5 PM at night, unless a user with the correct privileges is logged in.
Training

The system can be used for training via an appropriate application. In this scenario, the system should know that there is someone in the room. The user will need to be able to identify themselves and they may need to be able to interact with the content.

In addition to application management, the health and status of each terminal can be monitored. This can include, but is not limited to determining:
System power state, i.e. is it on or off.
If on, what the system is doing, i.e. local presentation, or app running.
What sources are connected.
The health of key system components such as power supplies and screen etc.
The connection state of screen and Interface.
Volume levels.

An administrator can also take control of the system and be able to switch inputs and change the volume etc.

In an example, a terminal 101a can retrieve data from a corporate service 105 such as Microsoft Active Directory and Exchange Server via the remote management apparatus 103. In this scenario a user can log onto the system by logging into a terminal which may then show their diary entries for the day for example. The entries can have a quick launch dialog box allowing the user to join a meeting simply by clicking a link or by touching a link if a touch enabled terminal is provided. As multiple applications are supported, it would not matter if the invite was for any one of the multiple applications available. A terminal 101a can also receive data directly from, for example, a TV service such as a subscription based service, a streaming service 109 or one or more web-based services 111 such as online streaming services for example.

In an example, control of a terminal can be provided by way of a hand held remote control and on screen user interface, however Smartphone and Tablet applications can also be used to control the system and interact with it. A touch screen version may also be provided where the touch screen provides the ability to select and control on screen functions. In an example, a user setup tool may be provided on apparatus 113 to enable the remote management apparatus 103 to be configured. For example, the apparatus can be used to populate, modify or delete a mapping of unique identifiers to operational parameters and profiles.

According to an example, a remote management apparatus can be a virtual machine instantiated over physical hardware. Accordingly, horizontal and/or vertical scaling of the remote management apparatus can be executed in response to a load variation as a result of a change to the number of active terminals of the system for example.

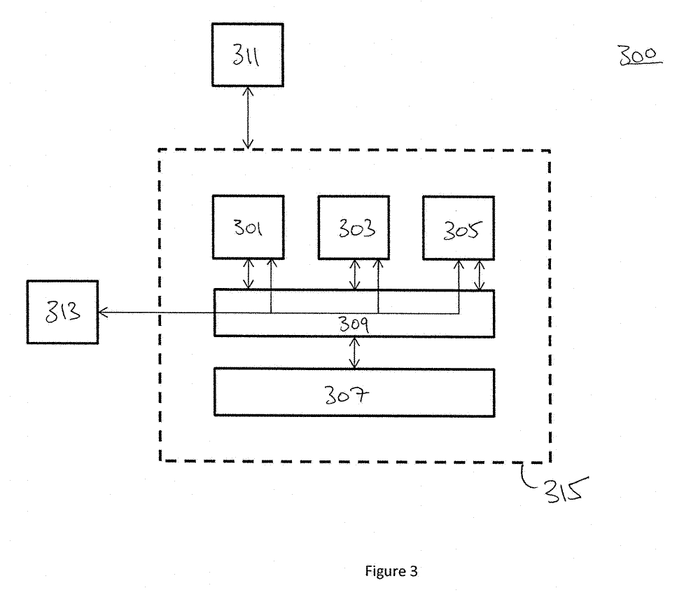

FIG. 3 is a schematic representation of a multimedia system 300 according to an example. Multiple virtual machines (VMs) 301, 303, 305 are in program execution over physical hardware 307 via a virtual machine monitor (VMM) 309. VMs 301, 303, in the example of FIG. 3, are remote management apparatus used to control, administer and manage a terminal or set of terminals 311. A VM 305 can be deployed in order to provide an additional remote management apparatus. For example, if use of the terminal or terminals 311 increases, such as if more users try to log into terminals for example, an additional VM 305 can be provided in order to (horizontally) scale the remote management provision in order to cope with the increased demand. Alternatively, or in addition, vertical scaling of an existing VM may be executed to increase computational capacity. For example, access to more of the physical hardware function 307 may be provided. Accordingly, it is possible to execute horizontal and/or vertical scaling of the remote management apparatus in response to a load variation as a result of a change to the number of active terminals of the videoconferencing system or the load experiences as a result of use of the terminals.

In the example of FIG. 3, an administrator 313 can directly access the virtual remote management devices 301-305. The virtualised part 315 of the system 300 may have access to a remote storage device (not shown) which can be used to store records for terminals and/or password data and so on.

A person of skill in the art would readily recognize that steps of various above-described methods can be performed by programmed computers. Herein, some examples are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The examples are also intended to cover computers programmed to perform said steps of the above-described methods.

The functions of the various elements shown in the Figures, including any functional blocks labelled as “processors” or “logic”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” or “logic” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The description and drawings merely illustrate the principles of the invention. It will thus be appreciated that those skilled in the art will be able to devise various arrangements that, although not explicitly described or shown herein, embody these principles and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The present inventions can be embodied in other specific apparatus and/or methods. The described embodiments are to be considered in all respects as illustrative and not restrictive.

In particular, the scope of the invention is indicated by the appended claims rather than by the description and figures herein. All changes that come within the meaning and range of equivalency of the claims are to be embraced within their scope.

1. A method for remote administration and management of a terminal in a multimedia system, the method comprising:
receiving, at a remote management apparatus, a unique identification from the terminal;
selecting, at the remote apparatus, a terminal operation parameter relating to the unique identification;
using the terminal operation parameter, generating a profile for the terminal configured to enable or disable one or more terminal applications and/or functions; and
transmitting the generated profile to the terminal.

2. A method as claimed in claim 1, wherein the unique identification relates to a terminal login configured to govern the functionality of the terminal.

3. A method as claimed in claim 2, wherein the terminal login maps to a terminal operational parameter configured to reduce, limit, maintain or otherwise enhance the terminal functionality.

4. A method as claimed in claim 1, further comprising:
transmitting data for broadcast at the terminal at a predetermined time;
storing the data at the terminal until the predetermined time; and
executing a broadcast at the terminal using the stored data at the predetermined time or in response to a trigger signal received at the terminal from the remote management apparatus, wherein the broadcast is configured for execution irrespective of a current profile for the terminal.

5. A method as claimed in claim 1, further comprising:
transmitting metric data from the terminal to the remote management apparatus, the metric data representing one or more usage parameters of the terminal and/or a terminal application.

6. A method as claimed in claim 1, wherein the remote management apparatus is a virtual machine instantiated over physical hardware, the method further comprising:
executing horizontal and/or vertical scaling of the remote management apparatus in response to a load variation as a result of a change to the number of active terminals of the videoconferencing system.

7. A method as claimed in claim 1, wherein generating the profile includes populating the profile with user password information.

8. A method as claimed in claim 1, further comprising using the remote management apparatus, overriding functions and/or applications executing on the terminal.

9. A method as claimed in claim 1, further comprising disabling the terminal in response to a predefined command or instruction transmitted by the remote management apparatus.

10. A method as claimed in claim 1, further comprising disabling the terminal at a predetermined time.

11. A multimedia system, comprising:
a remote management apparatus; and
a terminal;
the remote management apparatus operable to:
receive a unique identification from the terminal;
select a terminal operation parameter relating to the unique identification;
use the terminal operation parameter to generate a profile for the terminal, the profile being configured to enable or disable one or more terminal applications and/or functions; and
transmit the generated profile to the terminal.

12. A multimedia system as claimed in claim 11, wherein the remote management apparatus is operable map or logically associate the unique identification to a terminal operational parameter that is provided or configured to reduce, limit, maintain or otherwise enhance the terminal functionality.

13. A multimedia system as claimed in claim 11, wherein the remote management apparatus is configured to transmit data for broadcast to the terminal at a predetermined time;
the terminal operable to store the data until the predetermined time; and
execute a broadcast using the stored data at the predetermined time or in response to a trigger signal received at the terminal from the remote management apparatus, wherein the broadcast is configured for execution irrespective of a current profile for the terminal.

14. A multimedia system as claimed in claim 11, wherein the remote management apparatus is configured to receive metric data from the terminal representing one or more usage parameters of the terminal and/or a terminal application.

15. A multimedia system as claimed in claim 11, wherein the remote management apparatus is a virtual machine instantiated over physical hardware.

16. A multimedia system as claimed in claim 15, wherein the system is operable to execute horizontal and/or vertical scaling of the remote management apparatus in response to a load variation as a result of a change to the number of active terminals of the videoconferencing system.
